(19) United States
(12) Patent Application Publication
(10) Pub. No.: US 2021/0029432 A1
(43) Pub. Date: Jan. 28, 2021

(54) Vibratable Element and Method of Connecting Connection Wire to Vibratable Element

(71) Applicant: HOSIDEN CORPORATION, Osaka (JP)

(72) Inventor: Satofumi Nagaoka, Yao-shi (JP)

(73) Assignee: HOSIDEN CORPORATION, Osaka (JP)

(21) Appl. No.: 16/933,066

(22) Filed: Jul. 20, 2020

(30) Foreign Application Priority Data
Jul. 24, 2019 (JP) 2019-136163

(51) Int. Cl. H04R 1/06; H04R 7/26; H04R 7/04

(52) U.S. Cl. CPC H04R 1/06; H04R 2201/029; H04R 7/04; H04R 7/26

(57) ABSTRACT

A vibratable element including a vibratable element body, an adhesive part, and a connection wire. The adhesive part includes a thermosetting component and a thermoplastic component that are mixed together. The connection wire includes an adherend portion, and the adherend portion is bonded to a portion of the vibratable element body with the adhesive part.

### CROSS-REFERENCE TO RELATED APPLICATION

The present application claims priority under 35 U.S.C. § 119 of Japanese Patent Application No. 2019-136163 filed on Jul. 24, 2019, the disclosure of which is expressly incorporated by reference herein in its entirety.

### BACKGROUND OF THE INVENTION

### Technical Field

The invention relates to vibratable elements and methods of connecting a connection wire to a vibratable element.

### Background Art

In some conventional vibratable elements for loudspeakers, a connection wire is integrated with a vibration system component. For example, a tinsel wire (connection wire) is integrally sewn onto a face of a damper (vibration system component), or a tinsel wire is integrally bonded to a face of a damper with an acrylic emulsion adhesive that is tacky and maintains its tackiness even after dried (see Japanese unexamined patent publication No. 2002-218593).

### SUMMARY OF INVENTION

In the former configuration where the tinsel wire is sewn onto a face of the damper with a thread, the thread may damage the copper foils of the tinsel wire. Furthermore, the sewing work is cumbersome and leads to poor productivity.

In the latter configuration, since the acrylic emulsion adhesive for bonding the tinsel wire to the face of the damper is thermoplastic, the adhesive may soften after the bonding and when the vibratable element is heated due to external factors, such as the vibration of a voice coil fixed to the damper or the outside air temperature. When the vibratable element vibrates with the softened adhesive, the tinsel wire may break or peel off.

The invention provides a vibratable element in which a connection wire, such as a tinsel wire, is unlikely to break and/or peel off even when the vibratable element is heated. The invention also provides a method of connecting the connection wire to a vibratable element.

A vibratable element according to an aspect of the invention includes a vibratable element body, an adhesive part, and a connection wire. The adhesive part includes a thermosetting component and a thermoplastic component that are mixed together. The connection wire includes an adherend portion, and the adherend portion is bonded to a portion of the vibratable element body with the adhesive part.

In the vibratable element of this aspect, the adhesive part includes the thermosetting component and the thermoplastic component that are mixed together. When the vibratable element body is heated, the thermoplastic component of the adhesive softens, but the thermosetting component of the adhesive remains hard. It is therefore possible to reduce the possibility that the adherend portion of the connection wire breaks and/or peels off from the portion of the vibratable element body.

The adhesive may include a synthetic rubber and an elastomer that are mixed together. The synthetic rubber may include the thermosetting component and a part of the thermoplastic component. The elastomer may include another part, or the remaining part, of the thermoplastic component. The elastomer may impart flexibility to the adhesive part that is dried.

The synthetic rubber may be a thermoplastic rubber.

The elastomer may be a styrenic elastomer.

The vibratable element body may include a damper being said portion of the vibratable element body. The adherend portion of the connection wire may be bonded to a face of the damper with the adhesive part.

The vibratable element may be a vibratable element for a loudspeaker. The vibratable element body may include an edge portion and/or a diaphragm being said portion of the vibratable element body. The adherend portion of the connection wire may be bonded to a face of the edge portion and/or the diaphragm with the adhesive.

A method of connecting a connection wire to a vibratable element according to an aspect of the invention includes preparing a vibratable element body; preparing an adhesive, the adhesive including a thermosetting component, a thermoplastic component, and an organic solvent; preparing a connection wire, the connection wire including an adherend portion; applying the adhesive to at least one of the adherend portion of the connection wire or a portion of the vibratable element body, and subsequently affixing the adherend portion of the connection wire to the portion of the vibratable element body; and drying the adhesive to bond the adherend portion of the connection wire to the portion of the vibratable element body.

In the method of this aspect, the adhesive includes the thermosetting component and the thermoplastic component. When the vibratable element body is heated after the bonding, the thermoplastic component of the adhesive softens, but the thermosetting component of the adhesive remains hard. The method therefore reduces the possibility that the adherend portion of the connection wire breaks and/or peels off from the portion of the vibratable element body.

The adhesive may include a synthetic rubber in a range from 10% to 30%, an elastomer in a range from 10% to 30%, and the organic solvent. The synthetic rubber may include the thermosetting component and a part of the thermoplastic component. The elastomer may include another part, or the remaining part, of the thermoplastic component.

The organic solvent may constitute 60% or more of a total amount of all components of the adhesive. A proportion between the synthetic rubber and the elastomer may be adjusted so that the synthetic rubber and the elastomer constitutes the remaining 40% or lower of the total amount of all components of the adhesive.

The method may further include heating the adhesive after the drying of the adhesive, and thereby reactivating the adhesive and progressing cross-linking reaction of the thermosetting component of the adhesive.

The connection wire may be a tinsel wire. The heating of the adhesive may include allowing the reactivated adhesive to extend into interstices in a braid, and/or interstices between fibers, of the tinsel wire.

The vibratable element body may include a damper being said portion of the vibratable element body. The heating of the adhesive may include hot pressing the damper and the adherend portion of the connection wire affixed to the damper, and the hot pressing may cause formation of corrugations in the damper and deformation of the adherend portion of the connection wire into a shape conforming to the corrugations of the damper.

The heating of the adhesive may include the progressing of cross-linking reaction of the thermosetting component of the adhesive after the reactivation of the adhesive.

### BRIEF DESCRIPTION OF DRAWINGS

The present invention can be even more fully understood with the reference to the accompanying drawings which are intended to illustrate, not limit, the present invention.

FIG. 1 is a perspective view of a vibratable element for a loudspeaker according to the first embodiment of the invention, in which connection wires are bonded to a damper with adhesive parts.

FIG. 2 is a sectional view of the vibratable element.

FIG. 3 is an enlarged view of area 3, indicated in FIG. 2, of the vibratable element.

In the brief description of the drawings above and the description of embodiments which follows, relative spatial terms such as “upper”, “lower”, “top”, “bottom”, “left”, “right”, “front”, “rear”, etc., are used for the convenience of the skilled reader and refer to the orientation of the vibratable elements, and their constituent parts as depicted in the drawings. No limitation is intended by use of these terms, either in use of the invention, during its manufacture, shipment, custody, or sale, or during assembly of its constituent parts or when incorporated into or combined with other apparatus.

### DESCRIPTION OF EMBODIMENTS

The first embodiment of the invention and variations thereof will now be described. It should be noted that the constituents of the embodiment and the variations thereof to be described may be combined in any possible manner. Materials, shapes, dimensions, numbers, arrangements, etc. of the constituents of the vibratable element according to various aspects of the embodiment and variants thereof will be discussed below as examples only and may be modified as long as they achieve similar functions.

### First Embodiment

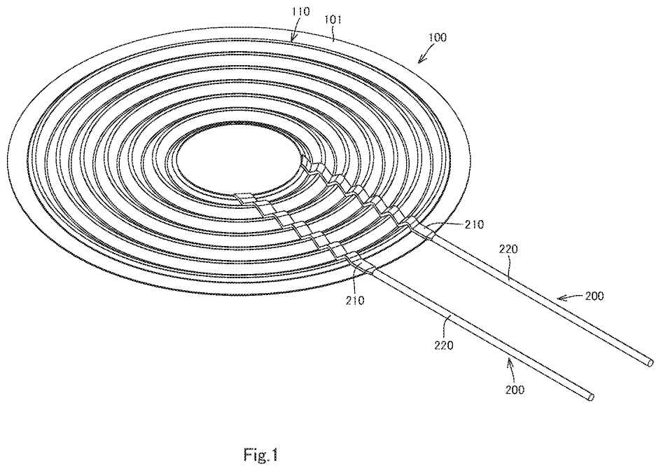

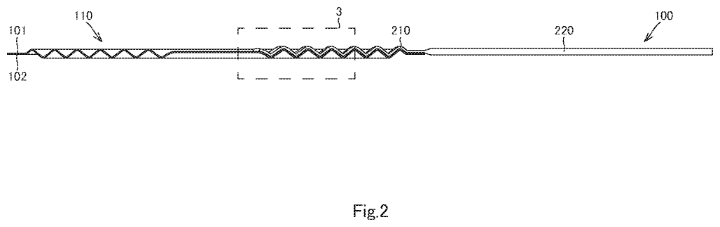

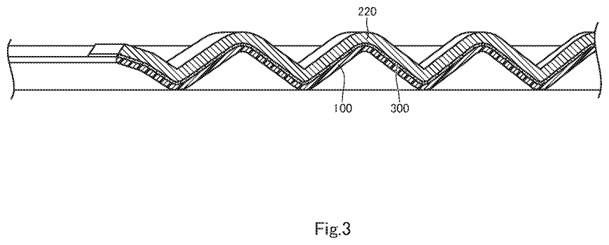

A vibratable element for a loudspeaker according to the first embodiment of the invention and variants thereof will be described with reference to FIGS. 1 to 3. FIGS. 1 to 3 show a vibratable element for a loudspeaker, according to the first embodiment, in which connection wires 200 are bonded to a damper 100 with adhesive parts 300.

The vibratable element for a loudspeaker includes a vibratable element body having a damper 100, a pair of connection wires 200, and a pair of adhesive parts 300.

The damper 100 is, for example, a thin plate generally in a shape of a ring (e.g., circular ring or polygonal ring) in plan view. The damper 100 may be made of Conex (meta-aramid fiber), cotton, polyester, or other material. The damper 100 may or may not be provided with corrugations 110. The damper 100 has a first face 101 on one side in the thickness direction of the damper 100, a second face 102 opposite to the first face 101 (on the other side in the thickness direction), an inner edge, and an outer edge. The inner edge of the damper 100 is configured to be fixed to a coil bobbin of a tubular shape (having a circular or polygonal cross-section, for example). A voice coil is wound around the coil bobbin. In use, with the coil bobbin fixed to the inner edge of the damper 100, the voice coil vibrates to cause the damper 100 to vibrate. The outer edge of the damper 100 is configured to be fixed to a loudspeaker frame (not shown).

The connection wires 200 are round or flat tinsel wires in which the strands of copper foils wrapped around fibers. The connection wires 200 are connectable to the voice coil. Each connection wire 200 includes an adherend portion 210 and a lead-out portion 220. The adherend portion 210 of each connection wire 200 is bonded to a portion (hereinafter referred to as a “bonding portion”) of the first face 101 of the damper 100 with a respective adhesive part 300. In such bonded state, the adherend portions 210 extend from the inner edge to the outer edge of the damper 100. If the damper 100 is provided with the corrugations 110, the adherend portions 210 also have alternate furrows and ridges conforming to the corrugations 110. The lead-out portions 220 are contiguous with the respective adherend portions 210 and extend away from the damper 100.

Each adhesive part 300 contains a thermosetting component and a thermoplastic component that are mixed together. For example, each adhesive part 300 may contain a synthetic rubber and an elastomer that are mixed together.

The synthetic rubber may be, for example, a thermoplastic rubber, or may be a synthetic rubber other than a thermoplastic rubber. The synthetic rubber contains a part of the thermoplastic component of each adhesive part 300 (hereinafter also referred to as the thermoplastic component of the synthetic rubber), and also contains the thermosetting component of each adhesive part 300 (hereinafter also referred to as the thermosetting component of the synthetic rubber). The thermoplastic component of the synthetic rubber (such as a thermoplastic rubber) is constituted by at least one of chloroprene rubber (CR), acrylonitrile-butadiene rubber (NBR), or styrene-butadiene rubber (SBR). The thermosetting component of the synthetic rubber (such as a thermoplastic rubber) is constituted by a thermosetting phenolic resin. The mixture ratio of the thermoplastic component of the synthetic rubber to the thermosetting component of the synthetic rubber is in a range from 25:75 to 75:25.

The elastomer may preferably be a styrenic elastomer, or may be an elastomer of any other type. The elastomer includes another part, or the remaining part, of the thermoplastic component of each adhesive part 300. The elastomer imparts flexibility to each adhesive part 300 that is dried. In other words, each adhesive part 300 that is dried is flexible because it contains the elastomer.

The following discussion is directed to a method of connecting the connection wires 200 to the damper 100 of the above-described vibratable element for a loudspeaker.

First, an adhesive is prepared. The adhesive contains the thermosetting component of any of the above aspects, the thermoplastic component of any of the above aspects, and an organic solvent. In other words, the adhesive may contain the synthetic rubber described above, the elastomer described above, and the organic solvent.

The organic solvent may be any combination of methylcyclohexane, ethyl acetate, isopropyl alcohol, toluene, normal hexane, acetone, and/or the like. For example, the organic solvent may contain methylcyclohexane in a range between 25% to 45%, ethyl acetate in a range between 25% to 45%, isopropyl alcohol in a range between 1% to 10%, of the total amount of all components of the adhesive.

The organic solvent may preferably constitute 60% or more of the total amount of all components of the adhesive. This is because if the organic solvent constitutes less than 60% of the total amount of all components of the adhesive, such adhesive would have extremely increased viscosity, resulting in impaired workability of the bonding process. If the organic solvent includes three components of methylcyclohexane, ethyl acetate, and isopropyl alcohol, it is possible to adjust the proportion between the three components such that the three components constitute 60% or more of the total amount of all components of the adhesive.

The synthetic rubber may constitute from 10% to 30% preferably, or from 15% to 25%%, of the total amount of all components of the adhesive. If the synthetic rubber constitutes less than 10% of the total amount of all components of the adhesive, the adhesive contains too little thermosetting component of the synthetic rubber and is therefore sensitive to heat.

The elastomer may constitute from 10% to 30% preferably, or from 15% to 25%, of the total amount of all components of the adhesive. If the elastomer constitutes less than 10% of the total amount of all components of the adhesive, a large proportion of the elastomer is cross-linked. When subjected to heat, such adhesive would thermally cure to lose its adhesive properties.

The proportion between the synthetic rubber and the elastomer is adjusted within the above respective ranges of the synthetic rubber and the elastomer, so that the synthetic rubber and the elastomer constitute 40% or lower of the total amount of all components of the adhesive (i.e. constitute the remainder of the adhesive components excluding the organic solvent). To meet this condition, the respective upper limits of the synthetic rubber and the elastomer may preferably be, as described above, 30% or lower of the total amount of all components of the adhesive. For example, if the synthetic rubber and the elastomer respectively constitute 10% and 30%, or 30% and 10%, the sum of the synthetic rubber and the elastomer fall within the remaining 40% or less of the total amount of all components of the adhesive.

The adhesive may further contain formaldehyde. In this case, the adhesive preferably has the formaldehyde content of 600 ppm or less. Also in this case, it is preferable to adjust the proportions between the synthetic rubber, the elastomer, and the organic solvent such that the adhesive can contain formaldehyde. The formaldehyde may be omitted.

The adhesive of any of the above aspects is manufactured by a common method for manufacturing a synthetic rubber-based adhesive, in which method thermosetting and thermoplastic components are charged into, and dissolved in, an organic solvent. The thermosetting and thermoplastic components are thus mixed and dispersed in the organic solvent. If the thermosetting component constituted by a synthetic rubber, such as a thermosetting phenolic resin, and if the thermoplastic component constituted by an elastomer, the adhesive is manufactured by a common method for manufacturing a synthetic rubber-based adhesive, in which method a synthetic rubber and an elastomer are charged into, and dissolved in, an organic solvent. The synthetic rubber and the elastomer are thus mixed and dispersed in the organic solvent. An example of the adhesive is an adhesive with a prototype number ST3053 provided by Diabond Industry co., Ltd.

Along with the preparation of the adhesive described above, the damper 100 of the vibratable element body is prepared. The damper 100 at this stage is formed without corrugations 110. The connection wires 200 are also prepared.

The adhesive is applied to the bonding portions of the first face 101 of the damper 100 and/or to the adherend portions 210 of the connection wires 200. After that, the adherend portions 210 of the connection wires 200 are affixed to the bonding portions of the first face 101 of the damper 100. The adhesive is thus present between the adherend portions 210 of the connection wires 200 and the bonding portions of the first face 101 of the damper 100.

After that, the damper 100 with the connection wires 200 affixed thereto with the adhesive is placed into a high temperature chamber. The high temperature chamber is set to an appropriate temperature, such as in a range between 50° C. to 60° C. The damper 100, the connection wire 200, and the adhesive are heated by the hot air in the high temperature chamber for about 20 to 30 minutes. The adhesive is thus dried, with the organic solvent in the adhesive evaporated. Also, the cross-linking reactions of the thermosetting component and the thermoplastic component of the adhesive progress, so that the adhesive becomes the adhesive parts 300, which serve to bond the adherend portions 210 of the connection wires 200 to the bonding portions of the first face 101 of the damper 100. More particularly, if the adhesive before dried contains the synthetic rubber, the elastomer, and the organic solvent, the cross-linking reactions of the thermosetting phenolic resin (the thermosetting component) and the thermoplastic component of the synthetic rubber, and the cross-linking reaction of the elastomer, progress during the drying of the adhesive, so that the adhesive becomes the adhesive parts 300, which serve to bond the adherend portions 210 of the connection wires 200 to the bonding portions of the first face 101 of the damper 100. The elastomer of the adhesive parts 300 will maintain its flexibility even after the drying. It is possible to appropriately change the temperature in the high temperature chamber and the heating time, depending on the components of the adhesive, the shape and/or the size of the damper 100, and other factors.

After that, the damper 100, the adherend portion 210 of the connection wire 200, and the adhesive parts 300 are heated (reheated). In about 5 to 10 seconds after the start of the heating, the adhesive parts 300 are reactivated, softening the thermoplastic component of the adhesive parts 300 (for example, the thermoplastic component of the synthetic rubber, and the elastomer). The softened adhesive parts 300 extend into interstices in the braid, and/or interstices between the fibers of the connection wires 200. In about 10 to 15 seconds after the start of the heating, the cross-linking reaction of the thermosetting component of the adhesive parts 300 (for example, the thermosetting phenolic resin of the synthetic rubber) further progresses.

After that, the damper 100, the adherend portions 210 of the connection wires 200, and the adhesive parts 300 are cooled. They may be water cooled by circulating water in a mold housing them. Alternatively or additionally, they may be air cooled by blowing air, such as compressed air, to the mold. The cooling causes further progress of the cross-linking reaction of the thermoplastic component of the adhesive parts 300. As a result, the adherend portions 210 of the connection wires 200 are bonded to the bonding portions of the first face 101 of the damper 100 with the adhesive parts 300 again, now more firmly.

If the corrugations 110 are to be formed in the damper 100, the damper 100, to which the connection wires 200 are bonded with the adhesive parts 300 as described above but are not provided with the corrugations 110, is placed in a cavity of the mold in a hot press molding device and subjected to hot pressing, for example, at a temperature in a range between 90° C. and 130° C. and a pressure of 0.2 MPa. This hot pressing, in addition to serving as the above reheating, causes formation of the corrugations 110 in the damper 100 and deformation of the adherend portions 210 of the connection wires 200 into a shape conforming to the corrugations 110 of the damper 100. In this case, the cavity of the mold has such a shape corresponding to the damper 100 having the corrugations 110.

The hot pressing ends in about 10 to 15 seconds after the start of the heating, and then the mold of the hot press molding device is released to retrieve the damper 100, the adherend portions 210 of the connection wires 200, and the adhesive parts 300. This retrieval should be easy, without the adhesive parts 300 sticking to the mold, because of the further progress of the cross-linking reaction of the thermosetting component of the adhesive parts 300. It is possible to appropriately change the temperature, time, and pressure of the hot pressing, depending on the components of the adhesive, the shape and/or the size of the damper 100, and other factors.

The reheating step may be performed not by the hot pressing as described above, but by using the high temperature chamber or other heating means. If the corrugations 110 are to be formed in the damper 100, the reheating may be performed by the high temperature chamber or the above other heating means, after forming the corrugations 110 in the damper 100 and bonding the adherend portions 210 of the connection wires 200 to the bonding portions of the first face 101 of the damper 100 with the adhesive parts 300. Even if the damper 100 is to be provided without the corrugations 110, the reheating step may be performed by hot pressing, or by the high temperature chamber or the above other heating means. In the former case, the cavity of the mold for hot pressing has a shape corresponding to the damper 100 with no corrugations 110. If the reheating is performed by means other than hot pressing, the adhesive parts 300 may be directly cooled, such as by air cooling. The reheating step may be omitted.

The vibratable element for a loudspeaker and the connecting method described above provide at least the following technical features and effects.

(A) The adhesive parts 300 each contain the thermosetting component and the thermoplastic component that are mixed together. When the damper 100 is heated during use of the vibratable element, such as due to vibration of the voice coil wound around the coil bobbin fixed to the inner edge of the damper 100, or due to external factors such as the outside air temperature, the thermoplastic component of the adhesive parts 300 softens, but the thermosetting component of the adhesive parts 300 remains hard. This reduces the possibility that the adherend portions 210 of the connection wires 200 break and/or peel off from the damper 100.

(B) If the adhesive parts 300 each contain a synthetic rubber and an elastomer that are mixed together, the adhesive parts 300 are not likely to hinder vibration of the damper 100, suppressing performance degradation of the damper 100 when heated during use of the vibratable element. This is because the elastomer maintains its flexibility even after the drying, or after the drying and reheating, in the above connection of the connection wires 200 to the damper 100.

(C) If the elastomer is a styrenic elastomer, the adhesive parts 300 are not likely to hinder vibration of the damper 100, suppressing performance degradation of the damper 100 at a low temperature during use of the vibratable element. This is because the styrenic elastomer maintains its flexibility even at a low temperature

(D) If the connection method includes any reheating step described above, the reheating further progresses the cross-linking reaction of the thermosetting component of the adhesive parts 300. Therefore, when the damper 100 is heated during use of the vibratable element, such as due to vibration of the voice coil, or due to external factors such as the outside air temperature, such heating is not likely to cause further progress of the cross-linking reaction of the thermosetting component of the adhesive parts 300. It is therefore possible to suppress performance degradation during use of the damper 100 due to further progress of cross-linking reaction of the thermosetting component of the adhesive parts 300.

(E) If the connection method includes the reheating step by the hot pressing, it is possible to simultaneously conduct the formation of the corrugations 110 in the damper 100 and the reheating. Further, such connection method eases bonding the adherend portions 210 of the connection wires 200 to the damper 100 with the adhesive because the damper 100 to be bonded is in a flat shape.

The vibratable element and the connecting method of the invention are not limited to the above-described embodiments but may be modified in any manner within the scope of the claims. Some example modifications will be described below.

The invention is applicable to at least one connection wire. The or each connection wire of the invention may be a tinsel wire as described above, or may be any other conductive wire, such as a lead wire or a cable. The number of the adhesive parts of the invention may correspond to the number of the connection wires.

The organic solvent of the invention may constitute less than 60% of the total amount of all components of the adhesive. For example, if the adhesive is required to have a high viscosity, the organic solvent may constitute less than 60% of the total amount of all components of the adhesive. The thermosetting and thermoplastic components of the adhesive of the invention are not limited to the above-described examples but may be selected from any thermosetting and thermoplastic components that are soluble in the organic solvent.

The vibratable element body of the vibratable element of the invention may include the damper of the vibratable element for a loudspeaker as described above. The vibratable element body may include the damper of the vibratable element for a loudspeaker, a diaphragm of the vibratable element, and/or the edge portion of the vibratable element. In this case, it is preferable that the or each connection wire of any aspect described above include an adherend portion bonded to a face of the damper, the diaphragm, and/or the edge portion of the vibratable element body with the adhesive.

The vibratable element of the invention is not limited to a vibratable element for a loudspeaker but may be a vibratable element for a shaker. If the vibratable element body of the vibratable element for a shaker includes a damper, it is preferable that the or each connection wire of any aspect described above include an adherend portion bonded to a face of the damper with the adhesive parts.

The present invention can include any combination of these various features or embodiments above and/or below as set-forth in sentences and/or paragraphs. Any combination of disclosed features herein is considered part of the present invention and no limitation is intended with respect to combinable features.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

### REFERENCE SIGNS LIST

100: damper
101: first face
102: second face
110: corrugations
200: connection wire
210: adherend portion
220: lead-out portion
300: adhesive part

What is claimed is:

1. A vibratable element comprising:
a vibratable element body;
an adhesive part including a thermosetting component and a thermoplastic component that are mixed together; and
a connection wire including an adherend portion, the adherend portion being bonded to a portion of the vibratable element body with the adhesive part.

2. The vibratable element according to claim 1, wherein
the adhesive part includes a synthetic rubber and an elastomer that are mixed together,
the synthetic rubber includes the thermosetting component and a part of the thermoplastic component,
the elastomer includes another part, or the remaining part, of the thermoplastic component, and
the elastomer imparts flexibility to the adhesive part that is dried.

3. The vibratable element according to claim 2, wherein the synthetic rubber is a thermoplastic rubber.

4. The vibratable element according to claim 2, wherein the elastomer is a styrenic elastomer.

5. The vibratable element according to claim 3, wherein the elastomer is a styrenic elastomer.

6. The vibratable element according to claim 1, wherein
the vibratable element body includes a damper being said portion of the vibratable element body, and
the adherend portion of the connection wire is bonded to a face of the damper with the adhesive part.

7. The vibratable element according to claim 1, wherein
the vibratable element is a vibratable element for a loudspeaker,
the vibratable element body includes an edge portion and/or a diaphragm being said portion of the vibratable element body, and
the adherend portion of the connection wire is bonded to a face of the edge portion and/or the diaphragm with the adhesive part.

8. A method of connecting a connection wire to a vibratable element, the method comprising:
preparing a vibratable element body;
preparing an adhesive, the adhesive including a thermosetting component, a thermoplastic component, and an organic solvent;
preparing a connection wire, the connection wire including an adherend portion;
applying the adhesive to at least one of the adherend portion of the connection wire or a portion of the vibratable element body, and subsequently affixing the adherend portion of the connection wire to the portion of the vibratable element body; and
drying the adhesive to bond the adherend portion of the connection wire to the portion of the vibratable element body.

9. The method according to claim 8, wherein
the adhesive includes a synthetic rubber in a range from 10% to 30%, an elastomer in a range from 10% to 30%, and the organic solvent,
the synthetic rubber includes the thermosetting component and a part of the thermoplastic component, and
the elastomer includes another part, or the remaining part, of the thermoplastic component.

10. The method according to claim 9, wherein
the organic solvent constitutes 60% or more of a total amount of all components of the adhesive, and
a proportion between the synthetic rubber and the elastomer is adjusted so that the synthetic rubber and the elastomer constitutes the remaining 40% or lower of the total amount of all components of the adhesive.

11. The method according to claim 8, further comprising heating the adhesive after the drying of the adhesive, and thereby reactivating the adhesive and progressing cross-linking reaction of the thermosetting component of the adhesive.

12. The method according to claim 9, further comprising heating the adhesive after the drying of the adhesive, and thereby reactivating the adhesive and progressing cross-linking reaction of the thermosetting component of the adhesive.

13. The method according to claim 10, further comprising heating the adhesive after the drying of the adhesive, and thereby reactivating the adhesive and progressing cross-linking reaction of the thermosetting component of the adhesive.

14. The method according to claim 11, wherein
the connection wire is a tinsel wire, and
the heating of the adhesive includes allowing the reactivated adhesive to extend into interstices in a braid, and/or interstices between fibers, of the tinsel wire.

15. The method according to claim 11, wherein
the vibratable element body includes a damper being said portion of the vibratable element body, and
the heating of the adhesive includes hot pressing the damper and the adherend portion of the connection wire affixed to the damper, and the hot pressing causes formation of corrugations in the damper and deformation of the adherend portion of the connection wire into a shape conforming to the corrugations of the damper.

16. The method according to claim 12, wherein
the vibratable element body includes a damper being said portion of the vibratable element body, and
the heating of the adhesive includes hot pressing the damper and the adherend portion of the connection wire affixed to the damper, and the hot pressing causes formation of corrugations in the damper and deformation of the adherend portion of the connection wire into a shape conforming to the corrugations of the damper.

17. The method according to claim 13, wherein
the vibratable element body includes a damper being said portion of the vibratable element body, and
the heating of the adhesive includes hot pressing the damper and the adherend portion of the connection wire affixed to the damper, and the hot pressing causes formation of corrugations in the damper and deformation of the adherend portion of the connection wire into a shape conforming to the corrugations of the damper.

18. The method according to claim 15, wherein the heating of the adhesive includes the progressing of cross-linking reaction of the thermosetting component of the adhesive after the reactivation of the adhesive.

19. The method according to claim 16, wherein the heating of the adhesive includes the progressing of cross-linking reaction of the thermosetting component of the adhesive after the reactivation of the adhesive.

20. The method according to claim 17, wherein the heating of the adhesive includes the progressing of cross-linking reaction of the thermosetting component of the adhesive after the reactivation of the adhesive.
